(19) United States
(12) Patent Application Publication
(10) Pub. No.: US 2026/0011271 A1
(43) Pub. Date: Jan. 8, 2026

(54) MULTIFUNCTIONAL DIGITAL DOOR SYSTEM

(71) Applicant: Thomas Rowe, Jacksonville, FL (US)

(72) Inventor: Thomas Rowe, Jacksonville, FL (US)

(21) Appl. No.: 19/257,907

(22) Filed: Jul. 2, 2025

Related U.S. Application Data
(60) Provisional application No. 63/667,756, filed on Jul. 4, 2024.

(51) Int. Cl. G09F 23/00; E06B 7/28; G06F 1/18; G06F 1/20; G06F 3/14

(52) U.S. Cl. CPC G09F 23/00; E06B 7/28; G06F 1/189; G06F 1/20; G06F 3/14

(57) ABSTRACT

A multifunctional door system is disclosed. The multifunctional door system comprises a door leaf configured to be movable relative to a frame assembly and comprising a display unit integrated into the door leaf and viewable through a front panel. The display unit is configured to display multimedia data. Further, the door leaf comprises at least one processor configured to receive multimedia data from a cloud-based platform via a wireless communication interface; control the display unit to render the multimedia data based on a predefined scheduling protocol. The door leaf further comprises a power supply unit configured to provide an electrical power to the display unit, the at least one processor, and a plurality of components housed within the door leaf. Further, the display unit is a double-sided display and is operable to display the multimedia data while the door leaf remains functional for entry and egress operations.

### CROSS REFERENCE TO RELATED APPLICATION

The present application claims the benefit of U.S. Provisional Application No. 63/667,756 filed “Jul. 4, 2024” and is incorporated by reference herein.

### TECHNOLOGICAL FIELD

Example embodiments of the present disclosure generally relates to an architectural door, and more particularly relates to a multifunctional digital door system and a method thereof.

### BACKGROUND

Conventional door systems are primarily designed to provide entry and exit functionality and offer limited or no capability beyond physical access control. In public and commercial spaces such as retail outlets, transit stations, and event venues, there is a growing need to utilize high-visibility areas, including doors, for dynamic communication, safety alerts, promotional media, and environmental monitoring. However, existing display systems are often mounted externally, which can obstruct movement, pose safety hazards, and lack seamless integration with the infrastructure. Furthermore, current solutions do not offer a compact, integrated system that combines multimedia display capabilities, environmental sensing, safety assistance, and wireless content control within the door systems itself. The limitations result in underutilized surfaces, fragmented systems requiring multiple installations, and increased power consumption and maintenance costs.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a multifunctional digital door system is disclosed. The multifunctional digital door system comprises a door leaf configured to be movable relative to a frame assembly. The door leaf comprises a display unit integrated into the door leaf and viewable through a front panel. The display unit is configured to display a multimedia data. Further, the door leaf comprises a memory having one or more computer readable instructions. Further, the door leaf comprises at least one processor disposed within the door leaf and operatively coupled to the display unit. The at least one processor is configured to receive the multimedia data from a cloud-based platform via a wireless communication interface. Further, the at least one processor is configured to control the display unit to render the multimedia data based on a predefined scheduling protocol. The door leaf further comprises a power supply unit operationally coupled to the at least one processor. The power supply unit is configured to provide an electrical power to the display unit, the at least one processor, and a plurality of components housed within the door leaf. Further, the display unit is a double-sided display and is operable to display the multimedia data while the door leaf remains functional for entry and egress operations.

In some embodiments, the frame assembly comprises a pair of jambs, a header, and a threshold configured to mount the door leaf within a building opening.

In some embodiments, the pair of jambs are configured to support mounting of one or more pivot hinges for an unobstructed movement of the door leaf. The header includes a door closer configured to automatically return the door leaf to a second position from a first position. The first position is an open state of the door leaf and the second position is a closed state of the door leaf.

In some embodiments, the plurality of components comprises at least of an image capturing device, an alert unit, a speaker, a QR scanner, a cooling system, a safety assistance unit, and a data analytics unit, each operatively coupled to the at least one processor. The at least one processor is further configured to selectively activate one or more of the plurality of components in response to predefined conditions, environmental triggers, or a user input.

In some embodiments, the cooling system comprises at least one intake fan and at least one exhaust fan configured to create a directional airflow within the door leaf. Each of the at least two intake fan and the at least two exhaust fan is equipped with a mesh filter configured to block one or more debris from entering an internal compartment of the door leaf.

In some embodiments, the at least one processor is further configured to implement the predefined scheduling protocol. The predefined scheduling protocol enables a timed delivery and display of the multimedia data based on predefined time intervals, calendar schedules, or one or more environmental conditions.

In some embodiments, the multimedia data comprises at least one of advertising media, promotional content, public safety alerts, venue-specific information, venue-specific safety instructions, or real-time environmental notifications.

In some embodiments, the power supply unit is configured to receive the electrical power from a wall outlet. The power supply unit is configured to distribute the electrical power to the display unit, the at least one processor, and the plurality of components within the door leaf.

In some embodiments, the door leaf comprises a top rail and a bottom rail. The top rail includes an access panel housing one or more electrical components comprising at least one of a power switch, a control circuitry, electrical wiring, or a power distribution element. The bottom rail includes a kick plate to assist a manual operation of the door leaf.

In another example embodiment, a method is disclosed. The method comprising steps of receiving, via at least one processor disposed within a door leaf, a multimedia data from a cloud-based platform via a wireless communication interface. The method further comprising steps of controlling, via the at least one processor, a display unit to render the multimedia data based on a predefined scheduling protocol. The method further comprising steps of providing, via a power supply unit operationally coupled to the at least one processor, an electrical power to the display unit, the at least one processor, and a plurality of components housed within the door leaf. The method further comprising steps of displaying, via the display unit, the multimedia data. The display unit is a double-sided display and is operable to display the multimedia data while the door leaf remains functional for entry and egress operations.

In yet another example embodiment, a multifunctional door is disclosed. The multifunctional door comprises a frame assembly mounted within an architectural opening. Further, the multifunctional door comprises a door leaf coupled with the frame assembly. The door leaf comprises a display unit integrated into the door leaf and viewable through a front panel. The display unit is configured to display a multimedia data. The display unit is a double-sided display and is operable to display the multimedia data while the door leaf remains functional for entry and egress operations. The display unit is secured within the door leaf using one or more mounting rods and a plurality of impact rods positioned adjacent to the display unit for structural support and impact protection. The door leaf further comprises a top rail and a bottom rail. The top rail includes an access panel housing one or more electrical components comprising at least one of a power switch, a control circuitry, electrical wiring, or a power distribution element. The bottom rail includes a kick plate to assist a manual operation of the door leaf.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1A illustrates a block diagram of a multifunctional digital door system in accordance with an example embodiment of the present disclosure;

FIG. 1B illustrates another block diagram of the multifunctional digital door system in accordance with an example embodiment of the present disclosure;

FIG. 2 illustrates a block diagram of a server of the multifunctional digital door system in accordance with an example embodiment of the present disclosure;

FIG. 3 illustrates a sectional view of a door leaf in accordance with an example embodiment of the present disclosure;

FIG. 4 illustrates an isometric view of a leaf enclosure in accordance with an example embodiment of the present disclosure;

FIG. 5 illustrates an exploded view of a top rail in accordance with an example embodiment of the present disclosure;

FIG. 6 illustrates an exploded view of an interface assembly in accordance with an example embodiment of the present disclosure;

FIG. 7A illustrates a full-screen configuration of a display unit integrated within the door leaf in accordance with an example embodiment of the present disclosure;

FIG. 7B illustrates a standard-sized configuration of the display unit mounted within the door leaf in accordance with another example embodiment of the present disclosure;

FIG. 7C illustrates a specialty configuration of the display unit integrated into the door leaf in accordance with another example embodiment of the present disclosure;

FIGS. 8A-8D illustrate a cooling system and a direction of airflow within the multifunctional digital door system in accordance with an example embodiment of the present disclosure;

FIG. 9 illustrates an isometric view of a stopless design implemented within a side stile of the door leaf in accordance with an example embodiment of the present disclosure;

FIG. 10 illustrates a sectional view of a display protection unit implemented in the multifunctional digital door system in accordance with an example embodiment of the present disclosure;

FIG. 11A illustrates an exemplary scenario of the display unit of the multifunctional digital door system in accordance with a first example embodiment of the present disclosure;

FIG. 11B illustrates an exemplary scenario of the display unit of the multifunctional digital door system in accordance with a second example embodiment of the present disclosure;

FIG. 11C illustrates an exemplary scenario of the display unit of the multifunctional digital door system in accordance with a third example embodiment of the present disclosure;

FIG. 11D illustrates an exemplary scenario of the display unit of the multifunctional digital door system in accordance with a fourth example embodiment of the present disclosure;

FIG. 12 illustrates a front view of the display unit showing an alert in accordance with an example embodiment of the present disclosure;

FIG. 13 illustrates a perspective view of the door leaf in an open position with an indication light in accordance with an example embodiment of the present disclosure;

FIG. 14 illustrates a display brightness adjustment feature for adaptive control in the multifunctional digital door system, in accordance with an example embodiment of the present disclosure; and

FIG. 15 illustrates a flowchart showing a method for operating the multifunctional digital door system in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a multifunctional digital door system. Embodiments of the present disclosure may comprise a door leaf configured to be movable relative to a frame assembly. Embodiments of the present disclosure may comprise a display unit integrated into the door leaf and viewable through a front panel. The display unit may be configured to display a multimedia data. Embodiments of the present disclosure may comprise a firmware memory having one or more firmware computer readable instructions. Embodiments of the present disclosure may further comprise at least one processor. The at least one processor may be configured to receive the multimedia data from a remote cloud-based platform via a wireless communication interface. The at least one processor may be configured to control the display unit to render the multimedia data based on a predefined scheduling protocol. Embodiments of the present disclosure may further comprise a power supply unit operationally coupled to the at least one processor. The power supply unit may be configured to provide an electrical power to the display unit, the at least one processor, and a plurality of components housed within the door leaf. The display unit may correspond to a double-sided display and may be operable to display the multimedia data while the door leaf remains functional for entry and egress operations.

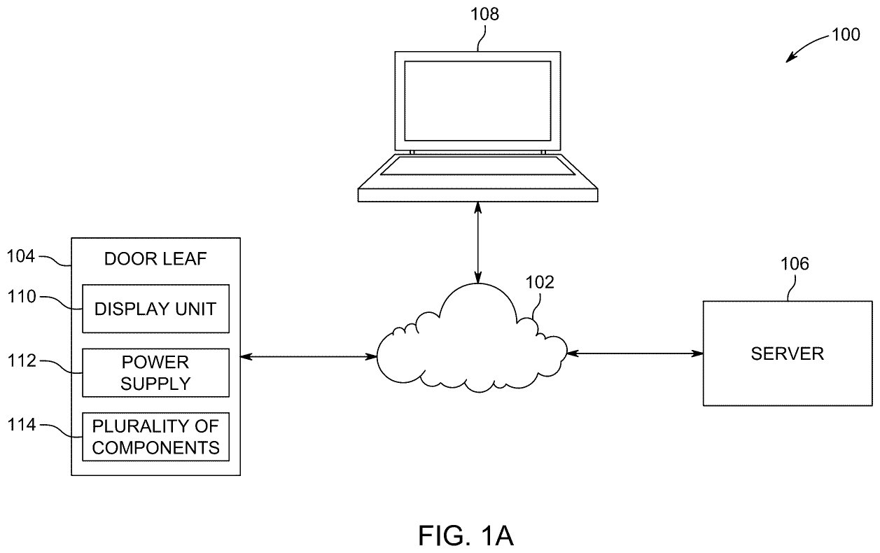

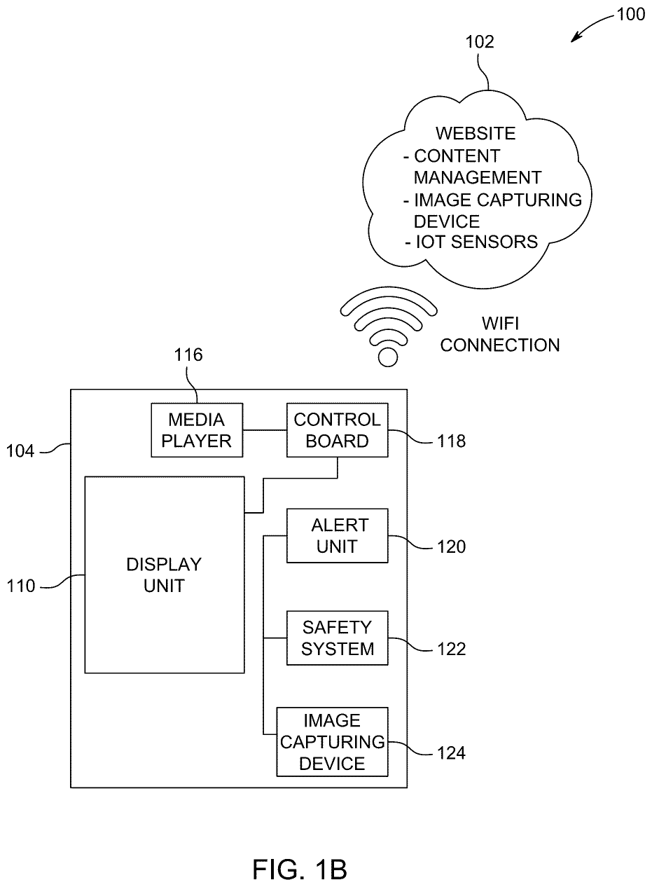

FIG. 1 illustrates a block diagram of a multifunctional digital door system 100 in accordance with an example embodiment of the present disclosure. FIG. 1B illustrates another block diagram of the multifunctional digital door system 100 in accordance with an example embodiment of the present disclosure.

In some embodiments, the multifunctional digital door system 100 may correspond to a movable barrier that may allow a user to enter or exit a space. The multifunctional digital door system 100 may be configured for ingress and egress operations. The multifunctional digital door system 100 may open or close to provide access, privacy, protection, or security. The multifunctional digital door system 100 may be implemented as one or more types. The one or more types may comprise at least one of a swinging door, a sliding door, and a revolving door. The multifunctional digital door system 100 may be installed at one or more locations. The one or more locations may comprise at least one of a smart house, a shopping mall, a corporate office, a factory, a stadium, a hospital, an airport, an institution, a museum, or a theatre. The multifunctional digital door system 100 may be customizable as desired by the user.

In some embodiments, the multifunctional digital door system 100 may serve one or more purposes comprising at least one of a functional purpose and an aesthetic purpose. The multifunctional digital door system 100 may enhance an architectural appeal of an installation site while facilitating the ingress and the egress operations. The multifunctional digital door system 100 may be configured to support one or more user preferences, environmental conditions, and usage requirements. The multifunctional digital door system 100 may also be adapted for manual, semi-automatic, or automatic operation based on user needs. The multifunctional digital door system 100 may be suitable for both interior installation and exterior installation. Further, the multifunctional digital door system 100 may be integrated into a newly constructed infrastructure or retrofitted into an existing infrastructure.

In some embodiments, the multifunctional digital door system 100 may comprise a network 102, a door leaf 104, a server 106, and a user device 108. The door leaf 104 may further comprise a display unit 110, a power supply unit 112, and a plurality of components 114. The plurality of components 114 may comprise at least one of a media player 116, a control board 118, an alert unit 120, a safety system 122, and at least one image capturing device 124.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the multifunctional digital door system 100 may connect to the network 102 in accordance with various wired and wireless communication protocols such as Transmission Control Protocol and Internet Protocol (TCP/IP), One or more travelers Datagram Protocol (UDP), and 2G, 3G, or 4G communication protocols.

In some embodiments, the door leaf 104 may correspond to a door panel. The door leaf 104 may further correspond to a primary surface that the user may interact with when opening or closing the multifunctional digital door system 100. The door leaf 104 may be constructed from one or more materials. The one or more materials may comprise at least one of glass, metal, wood, or composite materials.

In some embodiments, the door leaf 104 may be configured to be movable relative to a frame assembly. The movement of the door leaf 104 may be enabled by one or more hinges, sliding mechanisms, or pivot systems. The frame assembly may correspond to a fixed unit. The frame assembly may be configured to surround and support the movable door leaf 104. The frame assembly may be further configured to securely hold the door leaf 104 in place. The frame assembly may correspond to a frame made of a metallic or a non-metallic structural material. In one example, the frame assembly may be made of aluminum. The frame assembly may comprise at least one of a pair of jambs, a header, a threshold, and a door closer. The frame assembly may be configured to mount the door leaf 104 within a building opening.

In some embodiments, the pair of jambs may be positioned on a first vertical side and a second vertical side of the frame assembly. The first vertical side may correspond to a left side of the frame assembly. Further, the second vertical side may correspond to a right side of the frame assembly. The pair of jambs may be configured to support and distribute a mechanical load of the door leaf 104. Further, the pair of jambs may be configured to accommodate one or more pivot hinges. The one or more pivot hinges may enable an unobstructed swinging motion of the door leaf 104. The pair of jambs may be further configured to provide thermal management support. The thermal management support may include thermal insulation and heat dissipation as required. Further, the jambs may include internal routing spaces for electrical wiring associated with the functionalities of the multifunctional digital door system 100. Further, the multifunctional digital door system 100 may be interchangeably termed as a system 100.

In some embodiments, the header may be positioned horizontally at a top portion of the frame assembly. The header may be configured to provide structural reinforcement and maintain spacing between the pair of jambs. The header may be further configured to support an alignment and stability of the door leaf 104. Further, the header may be adapted to accommodate a door closing mechanism. The door closing mechanism may enable automatic or assisted closing of the door leaf 104 after it has been opened.

In some embodiments, the threshold may be positioned at a bottom portion of the frame assembly. The threshold may be fastened securely to a floor surface. The threshold may be configured to establish a sealed interface between the inside and the outside of the installation site. The sealed interface may assist in maintaining an airtight and weather-resistant barrier. In some embodiments, the door closer may be mounted on the header of the frame assembly. The door closer may correspond to a mechanical or an electromechanical component configured to control a closing motion of the door leaf 104. The door closer may be configured to enable the door leaf 104 to return to a closed position in a controlled manner after opening.

In some embodiments, the display unit 110 may be integrated into the door leaf 104. The display unit 110 may be viewable through a front panel positioned over the door leaf 104. The front panel may correspond to an impact panel. Further, the front panel may correspond to a cover portion of the door leaf 104. The front panel may be made from a transparent or a semi-transparent impact-resistant material such as acrylic, polycarbonate, or glass. The front panel may be configured to protect the display unit 110. The display unit 110 may be configured to display multimedia data. The multimedia data may include graphical designs, advertising media, informational messages, promotional content, public safety alerts, venue-specific information, venue-specific safety instructions, or real-time environmental notifications. The display unit 110 may be further used for artistic displays. Further, the display unit 110 may be used for information dissemination. The display unit 110 may be further used for branding purposes.

In some embodiments, the display unit 110 may correspond to a double-sided display and may be operable to display the multimedia data while the door leaf 104 remains functional for the ingress and the egress operations. The display unit 110 may be operable to function in both interior-facing and exterior-facing directions, thereby enhancing visibility for the user on either side of the door leaf 104. The display unit 110 may allow for uninterrupted ingress and egress operations. In one example, the display unit 110 may maintain high brightness and contrast for outdoor visibility and may support high-definition or ultra-high-definition resolutions. The front panel positioned over the door leaf 104 may be used on both sides of the door leaf 104. The front panel sheet may be rigid, lightweight, and may take high impact without breaking or shattering.

In some embodiments, the display unit 110 may correspond to a high-resolution display. The display unit 110 may be of one or more sizes. The display unit 110 may further correspond to a thin display. The display unit 110 may be a 2.57-inch-thick display. In one example, dimensions of the display unit may correspond to 50.11*29.26*2.57 inches. In another example, weight of the display unit may correspond to 88 pounds.

In some embodiments, the server 106 may be a computer or software module that is configured to provide centralized resources, data, or services to the user device 108 operated by the user. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network users to configure, monitor, and maintain network resources, security settings, and user access permissions from a centralized interface.

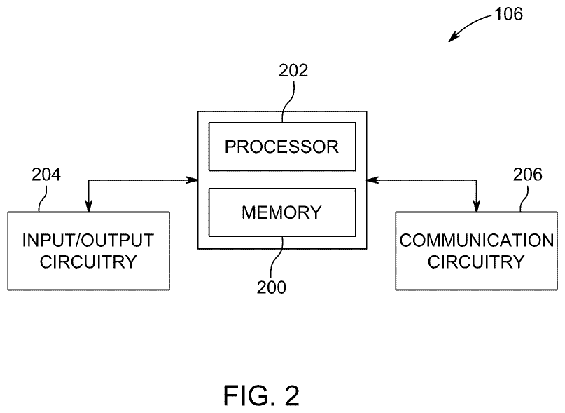

In some embodiments, the server 106 may be communicatively coupled to the door leaf 104. The server 106 may comprise a memory, and at least one processor (described in FIG. 2). The memory may have one or more computer readable instructions. The at least one processor may be communicatively coupled to the memory. In some embodiments, the server 106 may be configured to receive the multimedia data from a cloud-based platform via a wireless communication interface. The server 106 may be configured to manage, control, and update the multimedia data displayed on the display unit 110. The server 106 may receive the multimedia data from one or more remote sources. The one or more remote sources may include a cloud-based content management platform. The server 106 may be operable to establish communication with the cloud-based platform through a wireless communication interface. The wireless communication interface may include one or more communication technologies. The one or more communication technologies may comprise at least one of Wi-Fi, Bluetooth, Zigbee, or a cellular communication protocol.

In some embodiments, the server 106 may be configured to support real-time data updates, scheduled content synchronization, and remote configuration of the display unit 110. The server 106 may ensure continuous and seamless delivery of the multimedia data without interrupting the functional operations of the multifunctional digital door system 100. The server 106 may also be configured to provide a reliable communication link between the cloud-based platform and the display unit 110.

In some embodiments, the server 106 may be further configured to control the display unit 110 to render the multimedia data based on a predefined scheduling protocol. The predefined scheduling protocol may define specific rules or instructions that may determine when and how the different multimedia data is to be presented on the display unit 110. The server 106 may execute the predefined scheduling protocol to ensure that the multimedia content data is shown at intended times and durations. The server 106 may be configured to allow for a seamless user experience while optimizing visibility of the multimedia data based on time-sensitive requirements.

In some embodiments, the server 106 may be further configured to implement the predefined scheduling protocol. The predefined scheduling protocol may correspond to a set of timing rules stored in the server 106 or retrieved from the cloud-based platform. The predefined scheduling protocol may enable a timed delivery and rendering of the multimedia data based on one or more criteria. The one or more criteria may include predefined time intervals, calendar-based schedules, user-defined programming inputs, or environmental conditions such as ambient light levels, temperature, or motion detection. By dynamically adjusting the multimedia data, the multifunctional digital door system 100 may optimize energy usage, viewer engagement, and operational efficiency.

In some embodiments, the door leaf 104 may further comprise the power supply unit 112. The power supply unit 112 may be configured to provide an electrical power to the display unit 110, at least one processor (described in FIG. 2), and the plurality of components 114 housed within the door leaf 104. The power supply unit 112 may be configured to receive the electrical power from an external wall outlet. In one example, the power supply unit 112 may include power input circuitry for converting alternating current (AC) from the external wall outlet into a suitable direct current (DC) voltage required by the plurality of components 114 of the door leaf 104. The power supply unit 112 may optionally comprise protective features such as surge protection, thermal cutoffs, and overcurrent safeguards to ensure safe operation.

In some embodiments, the power supply unit 112 may be further configured to distribute the electrical power to the display unit 110, the at least one processor, and the plurality of components 114 housed within the door leaf 104. The distribution of the electrical power may be managed via a power distribution board or an internal circuitry that may regulate and channel the electrical power to the display unit 110, the at least one processor, and the plurality of components 114. The power supply unit 112 may be further configured to ensure that each of the plurality of components 114 may receive a stable voltage and an appropriate current. In some embodiments, the power supply unit 112 may be configured to support modular connectivity and may allow for the addition or replacement of the plurality of components 114 without requiring a full redesign of a power infrastructure.

In some embodiments, the plurality of components 114 may comprise the at least of an image capturing device 124, the alert unit 120, a speaker, a QR scanner, a cooling system, a safety assistance unit, and a data analytics unit, each operatively coupled to the at least one processor. The server 106 may be configured to selectively activate one or more of the plurality of components 114 in response to predefined conditions, environmental triggers, or a user input.

In some embodiments, the media player 116 may be configured to retrieve and stream the multimedia data to the display unit 110 from the cloud-based platforms. The control board 118 may correspond to a circuit board that may be configured for managing power distribution, signal processing, and overall coordination among various components within the door leaf 104. The alert unit 120 may be configured to generate visual or audio alerts in response to system notifications, user interactions, or safety triggers. The safety system 122 may comprise sensors and alert mechanisms such as motion detectors or edge safety switches, designed to prevent injuries during door operation. The image capturing device 124 may include one or more cameras for real-time surveillance, occupancy monitoring, or analytics collection, and may be mounted above or near the display unit 110.

In some embodiments, the image capturing device 124 may correspond to a security camera. The image capturing device 124 may be positioned above the display unit 110 and may be configured to capture one or more images in real time. The one or more images may include at least a video footage or a still image. The image capturing device 124 may be operable to capture and store the captured one or more images in the memory (described in FIG. 2) for a predetermined duration. The image capturing device 124 may be further configured to store and transmit the captured one or more images to a remote storage platform. The image capturing device 124 may be activated based on motion detection, time-based scheduling, or remote user commands. The image capturing device 124 may further support facial recognition or occupancy detection for security or analytics purposes.

In some embodiments, the alert unit 120 may correspond to a smart alert display unit. The alert unit 120 may be configured to generate a visual alert or an audible alert in response to emergency conditions, user notifications, or system status changes. The alert unit 120 may include LED indicators, a display panel, or an integrated buzzer. The alert unit 120 may be configured to work in coordination with the server 106 to notify the user in case of safety breaches, fire alerts, maintenance issues, or operational faults. The user may comprise building occupants or personnel.

In some embodiments, the speaker may correspond to an integrated speaker unit installed within a dedicated cut-out of the top rail of the door leaf 104. The speaker may be operable to output audio content associated with the multimedia data displayed on the display unit 110. The speaker may support synchronized playback of promotional content, alert tones, or safety messages. The speaker may be wirelessly managed by the server 106 and may support various volume levels and playback modes based on type of the multimedia data or time of day.

In some embodiments, the QR scanner may be configured to enable access control. The QR scanner may be mounted near a handle on a front surface of the door leaf 104. The QR scanner may be operable to scan and verify QR codes issued for ticketed entry, service access, or administrative purposes. Upon successful verification of the QR code, the QR scanner may transmit a signal to a solenoid lock to unlock the multifunctional digital door system 100. The QR scanner may also be used to track entry logs or integrate with a third-party authentication system.

In some embodiments, the cooling system may correspond to a powered cooling system. The cooling system may be configured to regulate an internal temperature of the multifunctional digital door system 100 to ensure optimal operation of the display unit 110 housed within the door leaf 104. The cooling system may include at least two intake fan, at least two exhaust fan, a mesh filter, a radiator based system, and heat vents. The cooling system may be automatically activated when the internal temperature exceeds a predefined threshold and may be deactivated once the internal temperature stabilizes.

In some embodiments, the safety assistance unit may comprise one or more safety devices configured to enhance user awareness and accessibility. The safety assistance unit may include components such as caution lights that may activate during door motion, and door-opening sound emitters that may alert the user of door operation. The safety assistance unit may be positioned in proximity to the threshold or the top rail. The safety assistance unit may assist in minimizing accidents, especially in high-traffic or public environments.

In some embodiments, the data analytics unit may be configured to track performance metrics associated with multimedia data displayed on the display unit 110. The data analytics unit may comprise a player box and an analytics camera. The player box may be mounted within the access panel of the door leaf 104. Further, the analytics camera may be positioned above the display unit 110. The data analytics unit may collect data such as viewer engagement, dwell time, or demographic insights. The server 106 may process the collected data and may further transmit the processed data to a cloud-based platform for further analytics or reporting.

In some embodiments, a user device 108 may be configured to interact with the multifunctional digital door system 100. The user device 108 may comprise a graphical user interface (GUI) that provides a user-friendly platform for a user, an administrator, or a service technician to access, configure, or manage various functionalities of the multifunctional digital door system 100. The GUI may be web-based and accessible through a browser, or may be implemented as a dedicated software application installed on computing devices. The user device 108 may include, but is not limited to, desktop computers, laptop computers, tablets, smartphones, or other mobile devices. The user device 108 may be operated to perform one or more actions including configuring the multimedia data, managing the predefined scheduling protocols, or controlling functionalities of the display unit 110, the server 106, and the plurality of components 114 housed within the door leaf 104.

It will be apparent to one skilled in the art that above-mentioned components of the system 100 have been provided only for illustration purposes, without departing from the scope of the disclosure.

FIG. 2 illustrates a block diagram of the server 106 of the multifunctional digital door system 100 in accordance with an example embodiment of the present disclosure.

In some embodiments, the server 106 may the memory 200, at least one processor 202, an input/output circuitry 204, and a communication circuitry 206. The at least one processor 202 may be configured to receive the multimedia data from a remote cloud-based platform via a wireless communication interface. The at least one processor 202 may be configured to manage, control, and update the multimedia data displayed on the display unit 110. The at least one processor 202 may receive the multimedia data from the one or more remote sources. The one or more remote sources may include the cloud-based content management platform. The at least one processor 202 may be operable to establish communication with the cloud-based platform through the wireless communication interface. The wireless communication interface may include the one or more communication technologies. The one or more communication technologies may comprise at least one of Wi-Fi, Bluetooth, Zigbee, or a cellular communication protocol.

In some embodiments, the at least one processor 202 may be configured to control the display unit 110 to render the multimedia data based on the predefined scheduling protocol. The predefined scheduling protocol may define specific rules or instructions that may determine when and how the different multimedia data is to be presented on the display unit 110. The at least one processor 202 may execute the predefined scheduling protocol to ensure that the multimedia content data is shown at intended times and durations. The at least one processor 202 may be configured to allow for a seamless user experience while optimizing visibility of the multimedia data based on time-sensitive requirements.

The at least one processor 202 may include suitable logic, circuitry, and/or interfaces operable to execute one or more computer-readable instructions stored in a memory 200 to manage various functionalities of the multifunctional digital door system 100. The at least one processor 202 may be configured to control the display unit 110, receive the multimedia data from a remote cloud-based platform, and operate a plurality of components housed within the door leaf 104, such as an image capturing device 124, the alert unit 120, QR scanner, cooling system, and safety assistance unit. The at least one processor 202 may further implement a predefined scheduling protocol for rendering the multimedia data, selectively activate components based on environmental triggers or user inputs, and store configuration settings, schedules, and logs in the memory 200. In some embodiments, the at least one processor 202 may decode and execute instructions received via a wireless communication interface, and may be realized using commercially available general-purpose controllers (e.g., INTEL® or AMD microcontrollers) or special-purpose controllers (e.g., digital signal controllers or Xilinx® SoC FPGA controllers).

In some embodiments, the memory 200 may be configured to store a set of instructions and data executed by the at least one processor 202 for operating various components of the multifunctional digital door system 100. The memory 200 may include one or more instructions executable by the at least one processor 202 to perform operations such as retrieving the multimedia data from a cloud-based platform, implementing scheduling protocols, and controlling display output. The memory 200 may be further configured to store system configuration parameters, content scheduling rules, display templates, and historical logs. In certain implementations, the memory 200 may store user-defined display preferences, environmental response settings, and multimedia content used for promotional or informational purposes. Additionally, the memory 200 may maintain operational diagnostics or event logs related to the power supply unit, cooling system, and other integrated components within the door leaf 104.

It is apparent to a person with ordinary skill in the art that the one or more computer readable instructions stored in the memory 200 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the system 100 may further comprise an input/output (I/O) circuitry 204. The I/O circuitry 204 may facilitate interaction between the user and the multifunctional digital door system 100 via the user device 108. The user device 108 may include any number of computing devices such as smartphones, tablets, laptops, or dedicated control terminals operated by users or service professionals. In some embodiments, the I/O circuitry 204 may act as a communication bridge to transmit commands, settings, or content between the user device 108 and various components housed within the door leaf 104. The I/O circuitry 204 may include both hardware and software elements that support bidirectional data exchange, including multimedia content uploads, display control commands, maintenance alerts, or scheduling preferences. For instance, the I/O circuitry 204 may include a graphical user interface (GUI) (not shown) that allows users to remotely configure content display schedules, monitor system status, or respond to real-time notifications. Additionally, the I/O circuitry 204 may comprise input elements such as touch panels or control buttons, and output elements such as status LEDs or audio indicators, enabling users to locally or remotely interact with the system 100 for diagnostics, security, or display customization.

In some embodiments, the server 106 may further comprise a communication circuitry 206. The communication circuitry 206 may allow the multifunctional digital door system 100 to exchange data or information with external platforms such as a remote cloud-based content management server, enterprise configuration databases, or third-party service applications. The communication circuitry 206 may include hardware interfaces and software modules configured for wired or wireless connectivity, enabling transmission and reception of multimedia data, system diagnostics, environmental triggers, and scheduling commands. In some embodiments, the communication circuitry 206 may include components such as Ethernet ports, Wi-Fi adapters, cellular modules, transceivers, antennas, and communication protocols (e.g., TCP/IP, HTTP, MQTT, SNMP) for establishing and maintaining network communication. These components may facilitate interaction between the at least one processor 202 and external servers, allowing the display unit 110 to receive multimedia content, system updates, or user engagement metrics. Further, the communication circuitry 206 may ensure real-time, secure, and reliable synchronization of display schedules, environmental data, and user-defined settings. The communication circuitry 206 may also enable the at least one processor 202 to dynamically manage operational logic and communication with other smart building infrastructure or IoT networks.

It will be apparent to one skilled in the art the above-mentioned components of the system 100 have been provided only for illustration purposes, without departing from the scope of the disclosure.

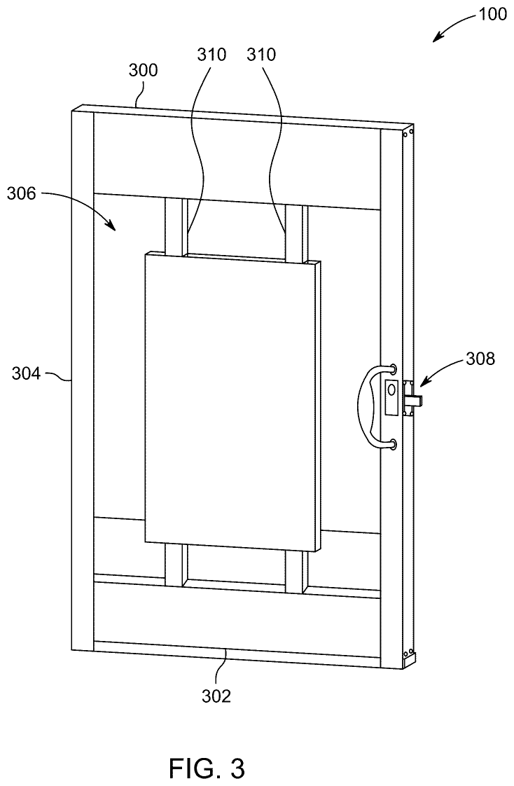

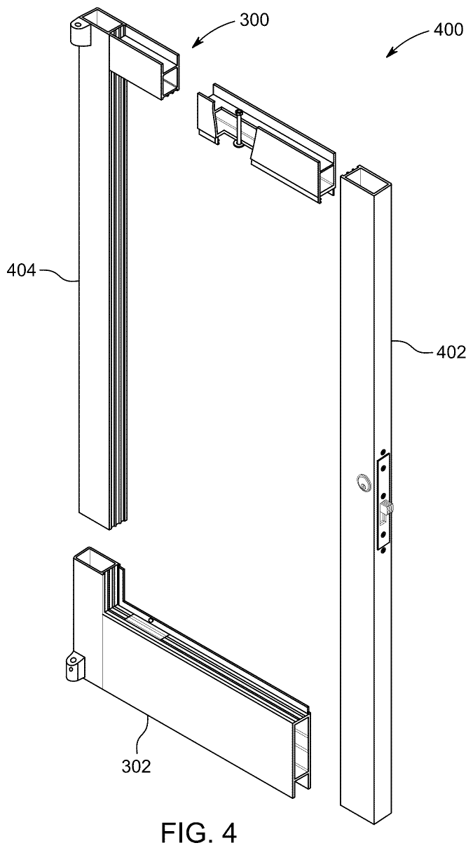

FIG. 3 illustrates a sectional view of the door leaf 104 in accordance with an example embodiment of the present disclosure. FIG. 4 illustrates an isometric view of a leaf enclosure 400 in accordance with an example embodiment of the present disclosure

In some embodiments, the door leaf 104 may comprise an integrated framework that may house and protect the plurality of components 114 of the door leaf 104. The door leaf 104 may comprise a leaf enclosure 400. The leaf enclosure 400 may correspond to a mounting platform for the display unit 110 and electrical and mechanical components housed within the door leaf 104. The leaf enclosure 400 may further include access panels located at a top portion and a handle-side portion for maintenance and access of the plurality of components 114. The leaf enclosure 400 may comprise a top rail 300, a bottom rail 302, one or more side stiles 304, the front panel 306, a door hardware 308, and a one or more mounting rods 310.

In some embodiments, the top rail 300 may be positioned along an upper edge of the door leaf 104. The top rail 300 may be constructed from an aluminum extrusion and may include an integrated access panel for housing one or more electrical components. The one or more electrical components may comprise a power box, a media player, a control switch, and an electrical wiring. The top rail 300 may further include ventilation openings or heat vents to allow for passive or active expulsion of hot air generated by the one or more electrical components. The access panel on a back portion of the top rail 300 may be serviceable via a flip-and-switch mechanism. The access panel may be configured to provide the user an access to a main power switch for safe servicing of internal electrical circuitry of the system 100.

In some embodiments, the bottom rail 302 may be located along a lower edge of the door leaf 104 and may function as a structural base and a kick plate. The bottom rail 302 may enable the user to assist in opening or stabilizing the door leaf 104 with foot pressure. The bottom rail 302 may include grooves to accommodate the front panel 306. In some embodiments, the bottom rail 302 may also incorporate one or more features for environmental protection. The one or more features may include at least one of traditional stops, shock absorbers, and weather-resistant sealing materials.

In some embodiments, the one or more side stiles 304 may be disposed vertically along a left edge and a right edge of the door leaf 104. The one or more side stiles 304 may form lateral structural members of the leaf enclosure 400 and may interconnect the top rail 300 and bottom rail 302. The one or more side stiles 304 may accommodate installation of one or more components. The one or more components may include at least one of a locking mechanism, a door handle, and a pivot hinge. The one or more stiles 304 may comprise at least one pivot hinge stile 400, and a lock stile 402. In some embodiments, the one or more side stiles 304 may include a removable access plate secured with flush screws. The removable access plate may enable internal access to the electrical wiring without compromising the exterior aesthetics. The one or more side stiles 304 may also include the grooves to receive and secure one or more edges of the front panel 306.

In some embodiments, the front panel 306 may correspond to one or more transparent or semi-transparent protective sheets installed on the front-facing and rear-facing surfaces of the door leaf 104. The front panel 306 may be made from impact-resistant materials such as polycarbonate, acrylic, or tempered glass. The front panel 306 may be configured to provide a clear viewing surface for the multimedia data displayed on the display unit 110. The front panel 306 may be further configured to protect the display unit 110 from physical damage.

In some embodiments, the door hardware 308 may include one or more mechanical components necessary for the operation and usability of the multifunctional digital door system 100. The one or more mechanical components may comprise handles, push bars, pivot hinges, and locking mechanisms. In some embodiments, the one or more mounting rods 310 may correspond to a plurality of fasteners configured to secure the plurality of components 114 to the door leaf 104. The one or more mounting rods 310 may include screws, bolts, brackets, and panel mounts used to install the display unit 110. The one or more mounting rods 310 may be distributed across the top rail 300, the bottom rail 302, and the one or more side stiles 304.

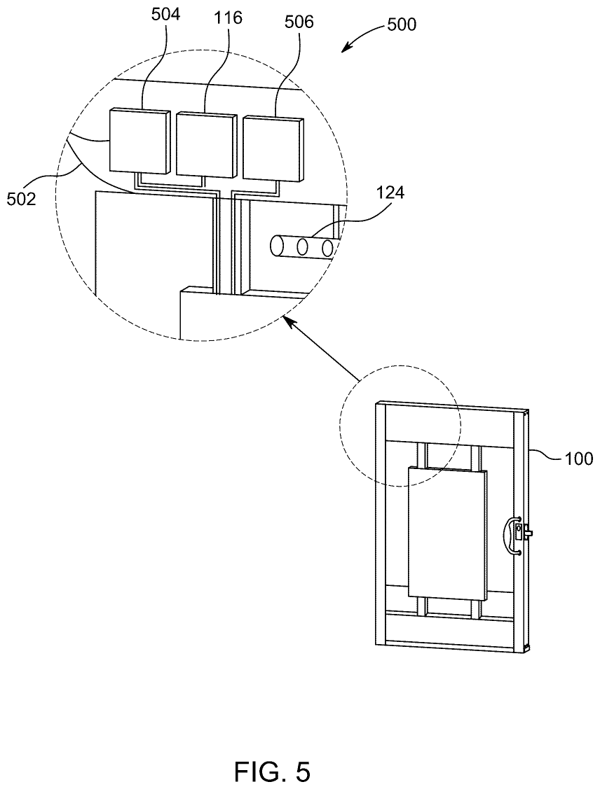

FIG. 5 illustrates an exploded view of the top rail 300 of the door leaf 104 in accordance with an example embodiment of the present disclosure.

In some embodiments, the top rail 300 may house an electrical system 500. The electrical system 500 may be configured to deliver the electrical power to the plurality of components 114 integrated within the door leaf 104. The electrical system 500 may include a power cord 502, a power box 504, the media player 116, one or more auxiliary modules 506, the image capturing device 124, and the display unit 110.

In some embodiments, the power cord 502 may be configured to connect the electrical system 500 to the power supply unit 112. The power cord 502 may be routed through a concealed pathway within the top rail 300 and may include standard insulation and shielding to ensure electrical safety and compliance with regulatory standards. The power cord 502 may correspond to an inlet for the electrical power and may be electrically coupled to the power box 504.

In some embodiments, the power box 504 may be electrically coupled to the power cord 502. The power box 504 may be configured to distribute the electrical power to the media player 116, the one or more auxiliary modules 506, the image capturing device 124, and the display unit 110 integrated within the electrical system 500. The power box 504 may include a voltage regulation circuit, surge protection features, and a main power switch for operational control and servicing. In some embodiments, the power box 504 may include one or more connectors that may facilitate plug-and-play installation of the media player 116 and the image capturing device 124.

In some embodiments, the media player 116 may be operatively connected to the power box 504 and communicatively linked to the display unit 110. The media player 116 may be configured to retrieve the multimedia data from the cloud-based platform. The media player 116 may be further configured to stream the retrieved multimedia data to the display unit 110. The media player 116 may be connected to the network 102 to enable remote content updates, scheduling, and playback control.

In some embodiments, the one or more auxiliary modules 506 may include one or more functional subsystems configured to extend the capabilities of the electrical system 500. The one or more auxiliary modules 506 may include at least one of control interfaces, sensory modules, lighting controls, or communication modules. The one or more auxiliary modules 506 may be mounted adjacent to or integrated with the media player 116. Further, the one or more auxiliary modules 506 may be powered via the power box 504.

In some embodiments, the image capturing device 124 may be positioned along an inner surface of the top rail 300 to provide an optimal field of view across a surveillance area. The image capturing device 124 may be operatively coupled to both the power box 504 and the media player 116. The image capturing device 124 may be configured to capture the one or more images of the surveillance area. In some embodiments, the display unit 110 may be mechanically mounted within the door leaf 104 and electrically interfaced with the media player 116. The display unit 110 may be configured to render the multimedia data. The electrical power for the display unit 110 may be supplied directly from the power box 504 via dedicated wiring.

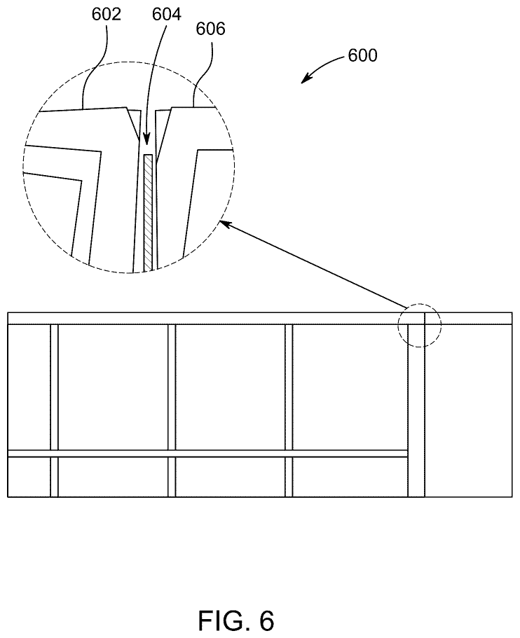

FIG. 6 illustrates an exploded view of an interface assembly 600 in accordance with an example embodiment of the present disclosure.

In some embodiments, the adapter plate 604 may be configured to enable structural integration of the multifunctional digital door system 100 with an existing storefront framework 602. The adapter plate 604 may function as a transitional interface between a hinge-facing jamb 606 and the pre-existing architectural assembly of the storefront framework 602. The adapter plate 604 may bridge dimensional or alignment differences between the multifunctional digital door system 100 and the older mounting surfaces of the storefront framework 602.

In some embodiments, the adapter plate 604 may be mounted between the storefront framework 602 and the hinge-facing jamb 606 to ensure secure installation and proper alignment of the door leaf 104. The adapter plate 604 may compensate for any structural offsets or spacing gaps resulting from mismatched geometries between the legacy storefront system and the newly introduced door leaf 104. The use of the adapter plate 604 may allow the multifunctional digital door system 100 to be retrofitted without requiring substantial modifications to the existing frame assembly. In some embodiments, the adapter plate 604 may include integrated mounting holes or fastening features to facilitate mechanical coupling with both the storefront framework 602 and the hinge-facing jamb 606. The adapter plate 604 may be composed of a durable and corrosion-resistant material to ensure long-term structural reliability.

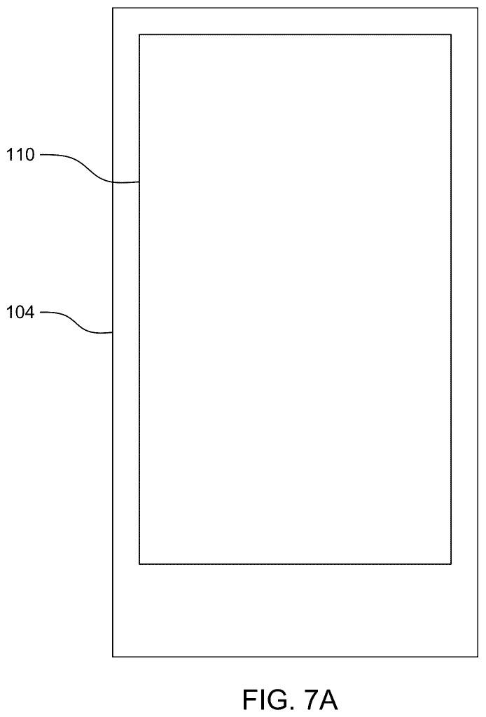

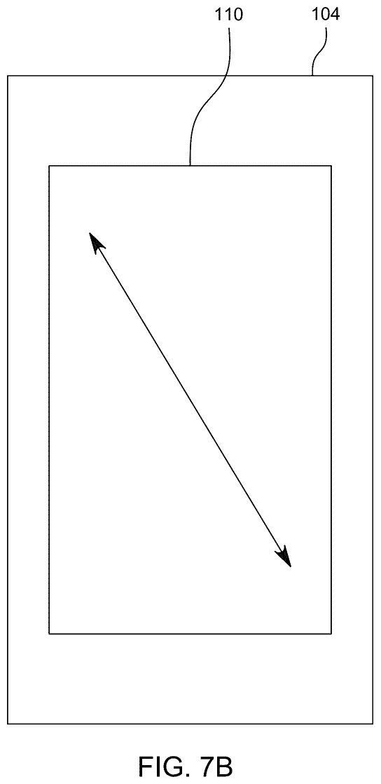

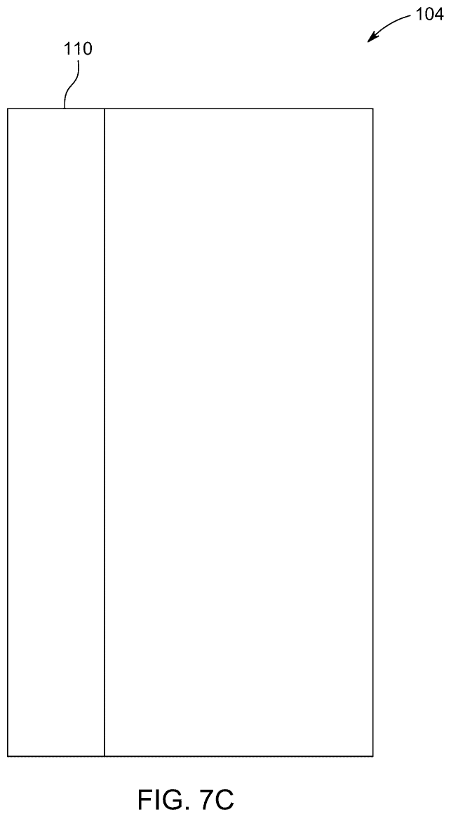

FIG. 7A illustrates a full-screen configuration of the display unit 110 integrated within the door leaf 104 in accordance with an example embodiment of the present disclosure.

In some embodiments, the display unit 110 may extend substantially across the entire surface area of the door leaf 104. The display unit 110 may be centrally positioned within the door leaf 104. The full-screen configuration of the display unit 110 may maximize a display area available for display of the multimedia data. The full-screen configuration may be well suited for high-impact digital advertising, video feeds, or informational signage in commercial or institutional environments. The display unit 110 may be protected by the front panel 306 composed of polycarbonate, acrylic, or other impact-resistant material. The full-screen configuration may also include reinforced one or more mounting rods 310 and robust electrical routing through the top rail 300 to ensure structural and operational integrity.

FIG. 7B illustrates a standard-sized configuration of the display unit 110 mounted within the door leaf 104 in accordance with another example embodiment of the present disclosure.

In some embodiments, the display unit 110 may be configured in a standard format. The standard-sized configuration of the display unit 110 may occupy a reduced yet centrally aligned portion of the door leaf 104. The display unit 110 may be mounted within a designated cavity framed by the internal structure of the leaf enclosure 400. The standard-sized configuration of the display unit 110 may allow for balanced integration of the plurality of components 114 within the door leaf 104. The standard-sized configuration may optimize visibility for the multimedia data while preserving space for additional interactive elements on the door leaf 104. The reduced size of the display unit 110 may also support lower power consumption and simplified maintenance.

FIG. 7C illustrates a specialty configuration of the display unit 110 integrated into the door leaf 104 in accordance with another example embodiment of the present disclosure.

In some embodiments, the display unit 110 may adopt a non-standard orientation within the door leaf 104. The specialty configuration may be a unique placement of the display unit 110 within the door leaf 104. In one example, the display unit 110 may correspond to a horizontally elongated display placed along a top edge or a bottom edge of the door leaf 104. In another example, the display unit 110 may correspond to a vertical strip display along one side of the door leaf 104. In yet another example, the display unit 110 may correspond to a display shaped to fit a custom branding area. The specialty configuration of the display unit 110 may be configured for directional signage, brand identity displays, localized alerts, or compliance with accessibility requirements.

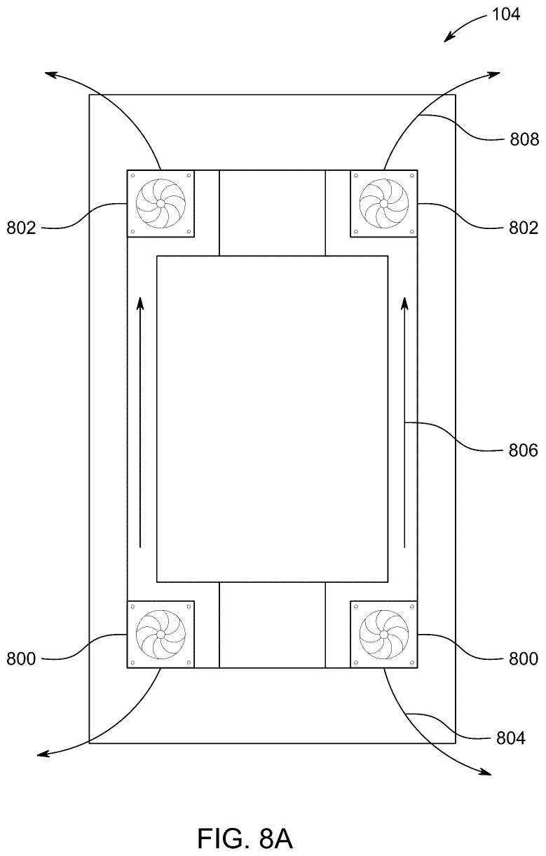

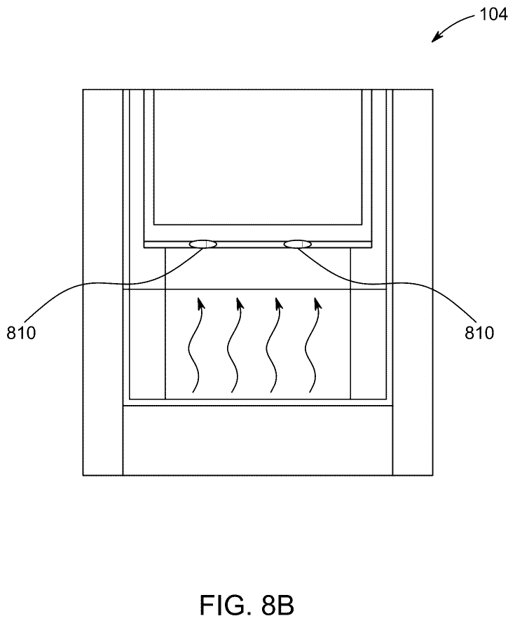

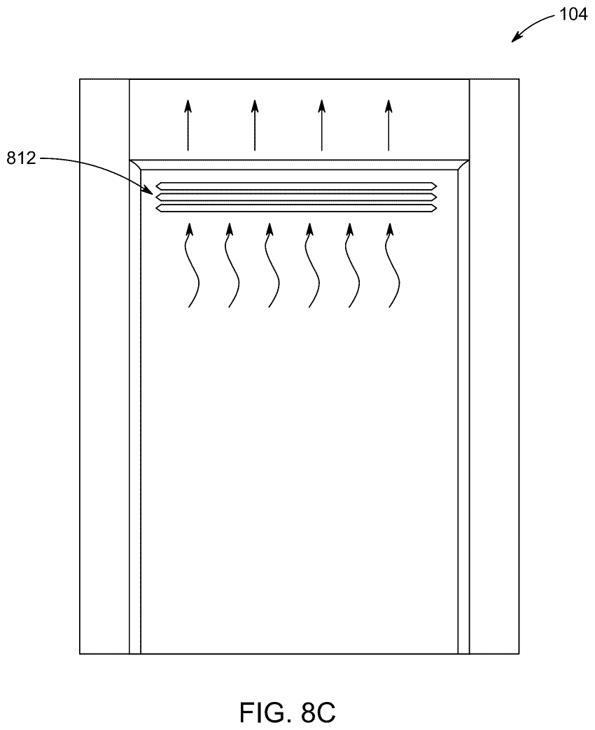

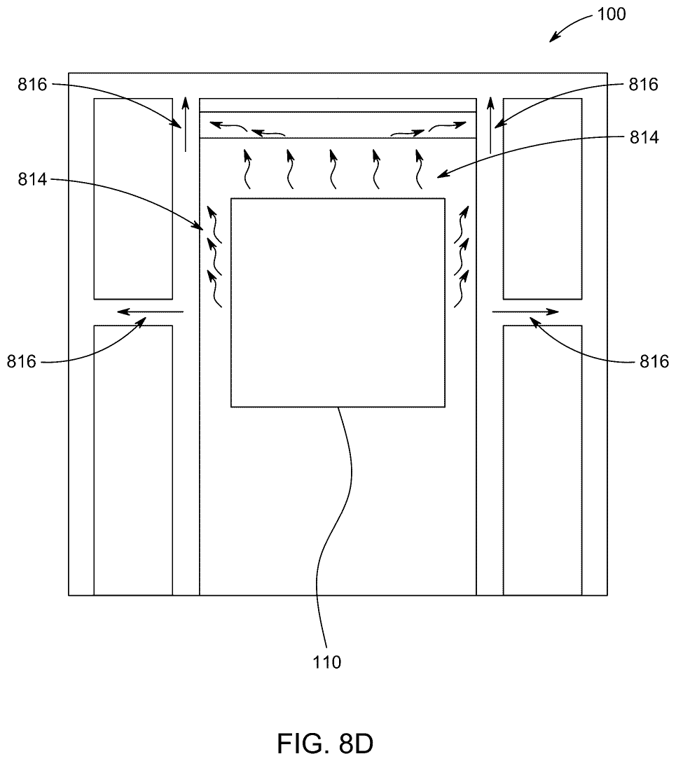

FIGS. 8A-8D illustrate a cooling system and the direction of airflow within the multifunctional digital door system 100 in accordance with an example embodiment of the present disclosure.

In some embodiments, the cooling system may be configured to regulate an internal temperature of the display unit 110 and the plurality of components 114 housed within the door leaf 104 of the multifunctional digital door system 100. The cooling system may be configured to ensure optimal performance and longevity of the display unit 110 and the plurality of components 114. The cooling system may comprise the at least one of two intake fans 800, the at least two exhaust fans 802, at least one temperature sensor (not shown), the mesh filter, the radiator based system, and the heat vents.

In some embodiments, FIG. 8A illustrates a front-facing sectional view of the cooling system within the multifunctional digital door system 100. The at least two intake fans 800 may be located at a bottom portion of the door leaf 104. The at least two intake fans 800 may be configured to draw in cool ambient air from an external environment as shown by an arrow 804. The draw cool air may be then directed upward along an inner surface of the door leaf 104 adjacent to the display unit 110 as shown by an arrow 806. The cool air may absorb heat emitted from the display unit 110. After absorbing the heat, the warm air may rise and may be expelled through the at least two exhaust fans 802 positioned along the top edge of the door leaf 104 as show by an arrow 808. The closed-loop airflow path from the external environment to the external environment via the cooling system may ensure effective dissipation of thermal energy away from heat-sensitive components. The heat-sensitive components may comprise the display unit 110 and the plurality of components 114.

In some embodiments, FIG. 8B illustrates a rear view of the door leaf 104, showing a backside airflow entry design. The polycarbonate sheet may form a rear panel of the door leaf 104 and may include a precisely engineered cut-out region at a lower portion of the rear panel. The cut-out region may allow an unobstructed entry of the cool air towards an intake fan 810 of the display unit 110. The airflow may be directed inward and upward to assist an intake operation of the cooling system embedded within the door leaf 104.

In some embodiments, FIG. 8C illustrates a heat vent design provided at the top portion of the door leaf 104. The polycarbonate sheet at the top portion may be cut horizontally to form one or more elongated slits 812. The one or more elongated slits 812 may act as passive exhaust vents. The one or more elongated slits 812 may be configured to enable warm air, which may naturally rise due to convection, to escape an internal chamber of the door leaf 104. In some embodiments, the at least two intake fans 800, the at least two exhaust fans 802, the cut-out region, the intake fan of the display unit, the one or more elongated slits may work in coordination with each other.

In some embodiments, FIG. 8D illustrates a top-down sectional view of the airflow circulation within the door leaf 104 of the multifunctional digital door system 100. As shown in FIG. 8D, the heat generated by the display unit 110 may rise vertically and moves toward the top portion of the door leaf 104 as shown by the arrows 814. The internal airflow may be channeled upward along both the left and right inner walls of the door leaf 104. The heated air may be then guided through internal ventilation ducts or air passages toward the top compartment. The at least two intake fans 800 positioned at the bottom portion may pull in cool air, which may travel upward along the display unit 110, may absorb the heat, and may help displace the warm air. The at least two exhaust fans 802, located at the top portion of the door leaf 104, may expel the heated air outward as shown by the arrows 816.

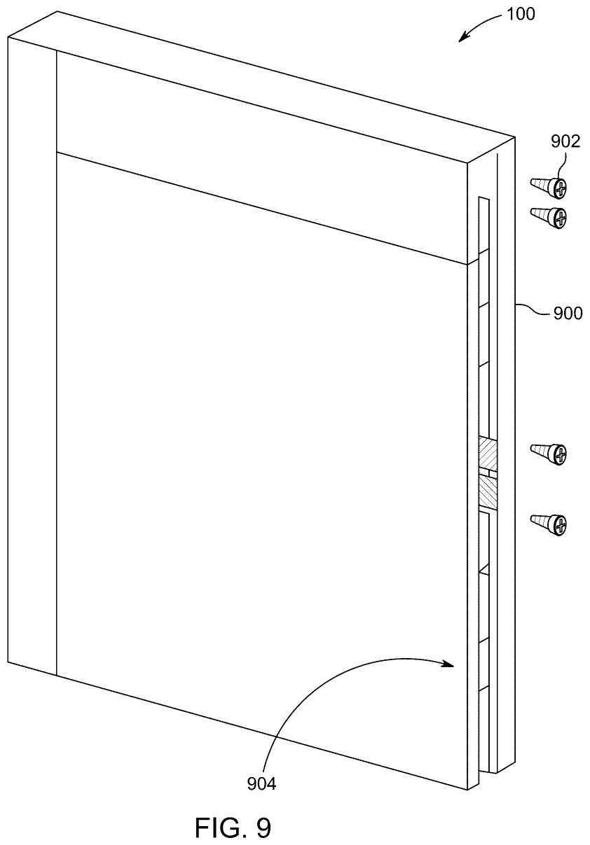

FIG. 9 illustrates an isometric view of a stopless design implemented within a side stile of the door leaf 104 in accordance with an example embodiment of the present disclosure.

In some embodiments, the stopless design may be configured to facilitate streamlined assembly, maintenance, and enhanced access to the electrical or the mechanical components within the door leaf 104. The stopless design may be configured to incorporate modular access and mounting features. In some embodiments, a lock-facing stile from the one or more stiles 304 may form one of the vertical structural members of the door leaf 104. The lock-facing stile may include predefined screw mounts. The predefined screw mounts may be configured to receive one or more fasteners and affix one or more structural plates. The one or more structural plates may include internal plates and external plates. The predefined screw mounts may be embedded into a stile's profile.

In some embodiments, the access plate 900 may be positioned over an internal channel of the lock-facing stile from the one or more stiles 304. The access plate 900 may be configured to allow non-destructive maintenance and removal of one or more electrical components housed within the one or more stiles 304. The one or more electrical components may include wiring harnesses, sensors, or the locking mechanisms. The access plate 900 may be secured using one or more screws to ensure a sleek and tamper-resistant external finish. Each of the one or more screws may correspond to a flush screws. The access plate 900 may be configured to be removed independently without requiring disassembly of the entire door leaf 104.

In some embodiments, a screw 902 may be provided to mechanically join the access plate 900 to the lock-facing stile. The screw 902 may be configured to ensure firm and vibration-resistant attachment while allowing ease of disassembly. In some embodiments, one or more spacers 904 may be provided along a mounting path between the access plate 900 and the lock-facing stile. The one or more spacers 904 may be configured to enable a formation of an airtight seal around a region of the access plate 900. The one or more spacers 904 may aid in thermal insulation, dust protection, and environmental sealing to safeguard the one or more electrical components.

In one example, the access plate 900 may be positioned on a front face or a back face of the door leaf 104, instead of being mounted over the internal channel of the lock-facing stile from the one or more stiles 304. The access plate 900 may be connected to the door leaf 104 via flush hinges, enabling the access plate 900 to swing open. The variation may allow execution flexibility and may maintain non-destructive maintenance capability for the one or more electrical components. The access plate 900 may use the one or more screws 902 and the one or more spacers 904 to ensure secure attachment, environmental sealing, and thermal insulation.

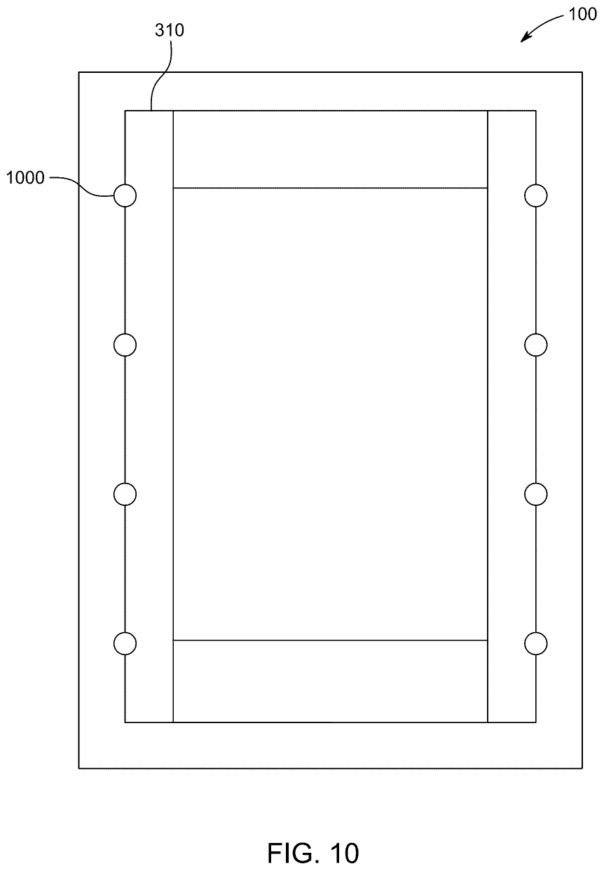

FIG. 10 illustrates a sectional view of a display protection unit implemented in the multifunctional digital door system 100 in accordance with an example embodiment of the present disclosure.

In some embodiments, the multifunctional digital door system 100 may include the display protection unit configured to mitigate the risk of damage to the display unit 110 integrated into the door leaf 104. The display protection unit may comprise one or more mounting rods 310 and a plurality of impact rods 1000 positioned adjacent to the display unit 110. The one or more mounting rods 310 may correspond to vertically oriented structural supports that may be configured to rigidly affixed to an internal frame of the door leaf 104. The one or more mounting rods 310 may be manufactured from at least one of metal, reinforced plastic, or composite materials. The one or more mounting rods 310 may feature regularly spaced slots, holes, or coupling fixtures that may enable secure attachment of the plurality of impact rods 1000. The plurality of impact rods 1000 rods may act as a foundation for the display protection unit and may ensure proper alignment parallel to a plane of the display unit 110.

In some embodiments, the plurality of impact rods 1000 may correspond to elongate cylindrical members mounted onto the one or more mounting rods 310. The plurality of impact rods 1000 may be positioned adjacent to and aligned along one or more vertical edges of the display unit 110. The plurality of impact rods 1000 may be configured to absorb or deflect one or more mechanical forces. The one or more mechanical forces may comprise at least accidental impacts, door collisions, or environmental disturbances. The plurality of impact rods 1000 may be further configured to reduce the likelihood of direct damage to the display unit 110. The plurality of impact rods 1000 may be composed of energy-absorbing or shock-resistant materials such as rubberized steel, coated aluminum, or polymeric composites. In some embodiments, the plurality of impact rods 1000 may form a protective barrier that may distribute incoming mechanical forces along the length. Further, the plurality of impact rods 1000 may be configured to minimize concentrated stress on the display unit 110. The alignment of the plurality of impact rods 1000 may ensure that the multimedia data on the display unit 110 may remain unobstructed while still being physically protected.

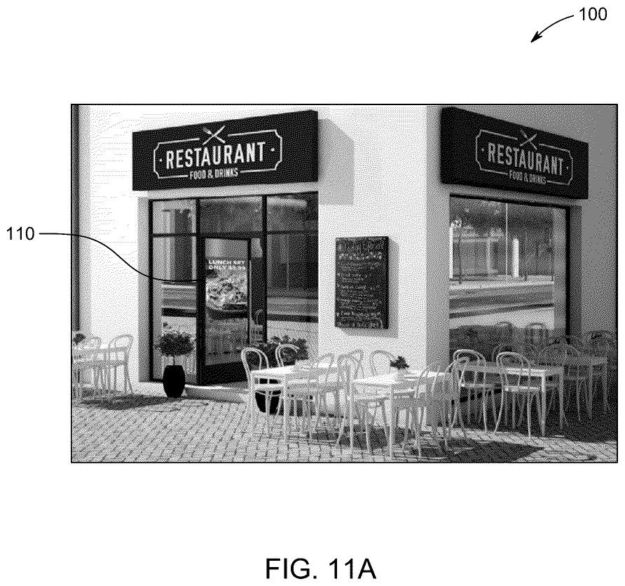

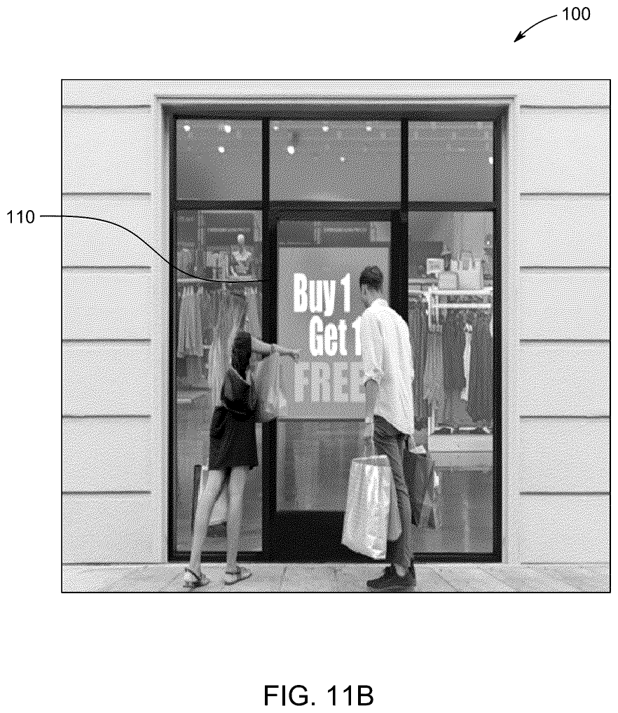

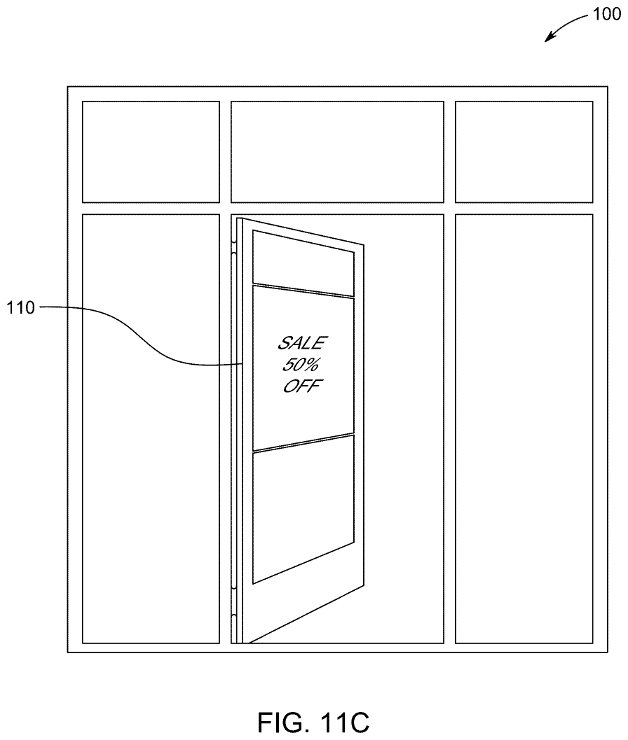

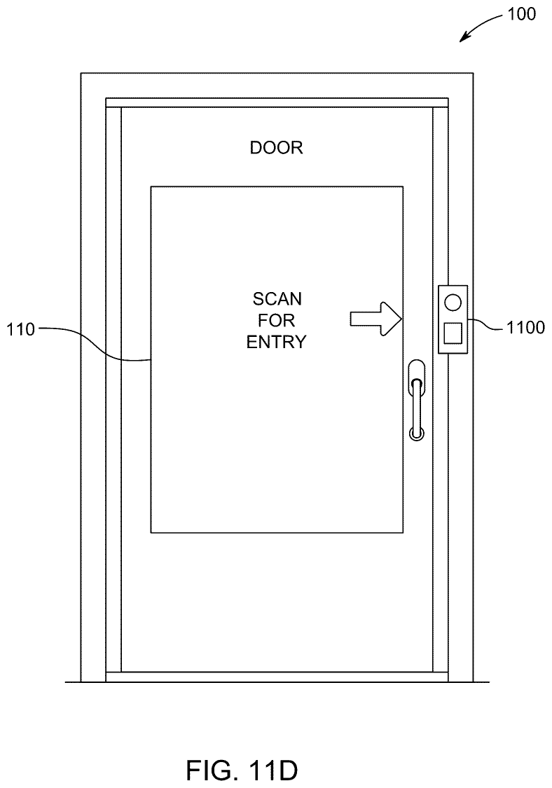

FIG. 11A illustrates an exemplary scenario of the display unit 110 of the multifunctional digital door system 100 in accordance with a first example embodiment of the present disclosure.

In some embodiments, the multifunctional digital door system 100 may be deployed at an entrance of a restaurant. The multifunctional digital door system 100 may be installed at a primary entryway of the restaurant, with the display unit 110 embedded within the door leaf 104. The display unit 110 may correspond to a digital signage panel configured to present promotional content such as food menus, discounts, or time-based offers. In one example, the display unit 110 may exhibit a promotional banner stating, “Lunch Set Only $9.99”. The display unit 110 may be dynamically rendered via the at least one processor 202 based at least on the predefined scheduling protocol or the cloud-based platform. In some embodiments, the multifunctional digital door system 100 may retain the function of enabling or restricting physical access, while the display unit 110 may be used as a marketing surface. The display unit 110 may be built to withstand ambient lighting, and may ensure high visibility during daytime operations.

FIG. 11B illustrates an exemplary scenario of the display unit 110 of the multifunctional digital door system 100 in accordance with a second example embodiment of the present disclosure.

In some embodiments, the multifunctional digital door system 100 may be installed at a retail store entrance. The multifunctional digital door system 100 may be positioned at a storefront of a retail outlet. The display unit 110 may be embedded in the door leaf 104. The display unit 110 may be configured to display one or more promotional messages. Further, the display unit 110 may be configured to render high-resolution, animated content promoting in-store deals. In one example, the promotional message displayed on the display unit 110 may comprise “Buy 1 Get 1 Free”. FIG. 11B may illustrate user engagement. As illustrated in FIG. 11B, one or more users may be facing or interacting with the display unit 110. The display unit 110 may comprise one or more sensors. The one or more sensors may correspond to a motion sensor or a proximity sensor. The one or more sensors may be configured to detect a presence of the one or more users. Further, the display unit 110 may be configured to activate adaptive brightness or change the multimedia data in real time based on the presence of the one or more users. The adaptive brightness or the change in the multimedia data may encourage foot traffic into the store by presenting personalized or eye-catching promotional message at just the right moment. The one or more user behavior metrics may optionally be tracked for analytic purposes. The one or more user behavior metrics may comprise at least one of dwell time, and interaction proximity. The one or more user behavior metrics may offer insights to a store manager for optimizing campaign performance.

FIG. 11C illustrates an exemplary scenario of the display unit 110 of the multifunctional digital door system 100 in accordance with a third example embodiment of the present disclosure.

In some embodiments, the display unit 110 embedded in the door leaf 104 may be actively rendering a promotional advertisement that may state “SALE 50% OFF.” The display unit 110 may support full-color digital rendering. Background color, font style, animation speed, and graphical elements of the sale banner may be altered to match the store's branding or campaign theme. In one example, the “SALE 50% OFF” promotional advertisement may appear at the sale banner in one or more colors to capture attention of the user and reflect seasonal trends. The one or more colors may comprise at least one of orange, yellow, cyan, pink, and blue. The customization features may be accessible via the user device 108 communicatively coupled to the at least one processor 202 or the cloud-based platform. Further, the display unit 110 may be designed with high brightness and anti-glare coatings. The display unit 110 may be configured to ensure optimal visibility of the promotional advertisement in both indoor and outdoor lighting conditions.

FIG. 11D illustrates an exemplary scenario of the display unit 110 of the multifunctional digital door system 100 in accordance with a fourth example embodiment of the present disclosure.

In some embodiments, the multifunctional digital door system 100 may be installed at a controlled-access location. The controlled-access location may comprise at least one of an office, a co-working space, an event venue, or a secure building. The display unit 110 embedded in the door leaf 104 may be configured to display a “Scan for Entry” message. The message may guide the user to present a digital credential for entry validation. The digital credential may comprise at least one of a QR code, a RFID-enabled badge, or a smartphone-based access pass. In some embodiments, the multifunctional digital door system 100 may be coupled with an external access management platform. Further, the multifunctional digital door system 100 may include a communication interface to interact with the external access management platform. The communication interface may include at least one of Wi-Fi, Bluetooth, and NFC. The display unit 110 may be configured to dynamically adapt the displayed message based at least on time of day, user role, or event schedule. In one example, when the user scans the digital credential at a QR scanner 1100 mounted on the lateral surface of the door leaf 104, the multifunctional digital door system 100 may validate the access and may unlock the door leaf 104 to permit entry.

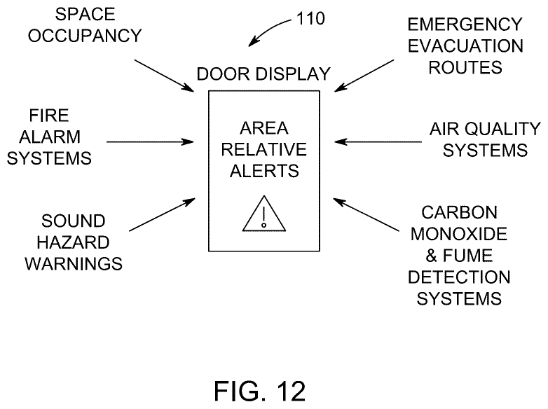

FIG. 12 illustrates a front view of the display unit 110 showing an alert in accordance with an example embodiment of the present disclosure.

In some embodiments, the display unit 110 may be configured to display the alert associated with the infrastructure where the multifunctional digital door system 100 is deployed. The display unit 110 may function as an intelligent communication interface that may visually convey situational alerts and hazard-related information based on real-time environmental inputs received from a plurality of building monitoring systems. The at least one processor 202 may be configured to process the received real-time environmental inputs. The at least one processor 202 may be configured to generate one or more alert signals based on the processed real-time environmental inputs. Further, the at least one processor 202 may be configured to generate an area relative alert based on the generated one or more signals. The display unit 110 communicatively coupled to the at least one processor 202 may be configured to display the generated area relative alert. In one example, the display unit 110 may display “Room at full capacity, avoid to go inside”.

In another example, the display unit 110 may be operatively coupled to a building-integrated fire alarm system. In response to a fire detection event, the display unit 110 may display visually distinct warnings such as flashing alerts, evacuation instructions, or designated exit routes. In yet another example, the display unit 110 may be operatively coupled to a sound hazard monitoring system configured to indicate high decibel levels or auditory risks within the infrastructure. The sound related alerts may include warnings such as “Hearing Protection Required” or “Sound Hazard Zone”. The sound related alerts may be particularly relevant in industrial, factory, or construction environments.

In yet another example, the display unit 110 may be communicatively coupled to a gas detection module. The gas detection module may include at least one of a carbon monoxide detection system and a fume detection system. Upon detecting elevated levels of one or more gases, the display unit 110 may display fume related alerts. fume related alerts may correspond to “Toxic Fumes Detected—Evacuate Area”. In yet another example, the display unit 110 may be configured to receive one or more environmental quality metrics from an air quality monitoring system. The air quality monitoring system may provide data on temperature, humidity, particulate matter, or CO₂ levels. Based on the received one or more environmental quality metrics, the display unit 110 may display warnings such as “Poor Air Quality—Use Ventilation” or “Maintain Fresh Air Flow”. In yet another example, the display unit 110 may be integrated with an emergency evacuation route system that may dynamically update based on the nature and location of the hazard. The display unit 110 may be configured to graphically indicate the most optimal and safe route to exit a building during emergencies.

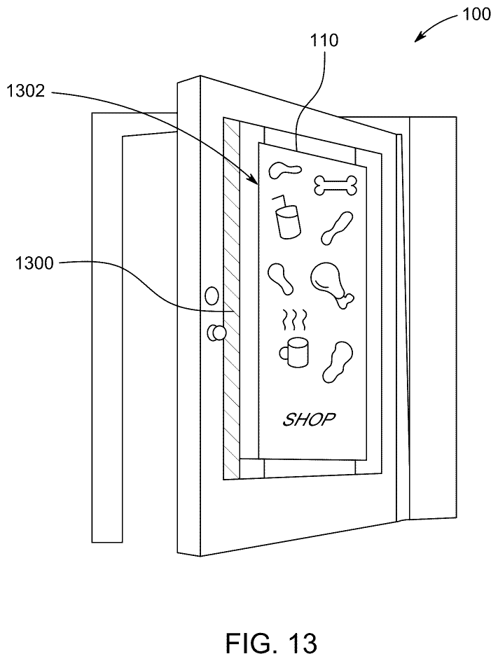

FIG. 13 illustrates a perspective view of the door leaf 104 in an open position with an indication light assembly 1300 in accordance with an example embodiment of the present disclosure.

In some embodiments, the display unit 110 mounted on the door leaf 104 may be configured to visually convey the multimedia data. The multimedia data may comprise advertisements, promotions, product illustrations, or operational notices relevant to the infrastructure where the multifunctional digital door system 100 may be deployed. In one example, the display unit 110 may display graphical icons 1302 indicative of food-related items along with a textual prompt “SHOP!”. The graphical icons 1302 may include chicken drumsticks, a steaming beverage, canned goods, and bone-shaped treats. The graphical icons 1302 may be representative of a retail store, a grocery outlet, or a pet food vendor. The multifunctional digital door system 100 may be deployed in commercial environments to capture customer attention and increase user engagement at entry points.

In some embodiments, the door leaf 104 may feature an indication light assembly 1300 positioned on a front face of the door leaf 104, adjacent to the display unit 110. The indication light assembly 1300 may correspond to a vertically striped pattern. The indication light assembly 1300 may be visible from both inside and outside of the door leaf 104. The indication light assembly 1300 may include a plurality of light sources configured to emit visual signals such as illumination patterns, colors, or flashing alerts. The plurality of light sources may include at least one of LEDs or electroluminescent strips. The indication light assembly 1300 may serve multiple purposes including guiding the user to an entrance. The indication light assembly 1300 may further highlight active entryways. Further, the indication light assembly 1300 may indicate door status (e.g., locked, unlocked, or in operation).

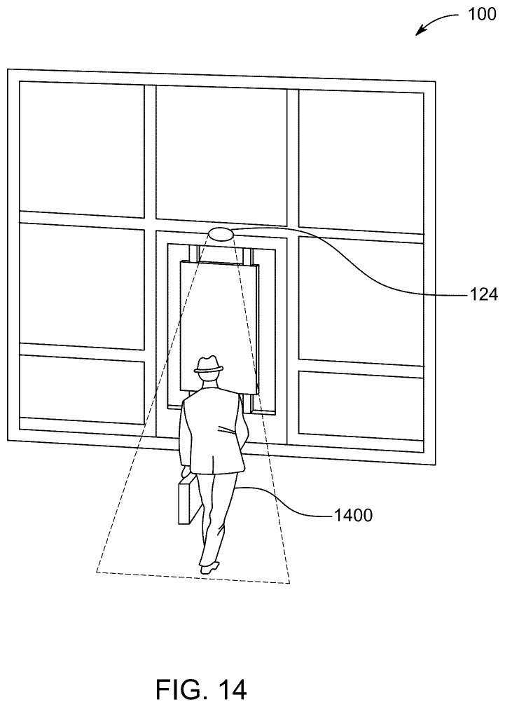

FIG. 14 illustrates a display brightness adjustment feature for adaptive control in the multifunctional digital door system 100, in accordance with an example embodiment of the present disclosure.

In some embodiments, the multifunctional digital door system 100 may include a display brightness adjustment feature to enhance user comfort and visibility. As illustrated in FIG. 14, the image capturing device 124 may be positioned above the display unit 110 and may be configured to detect the presence and proximity of a user 1400 approaching the door leaf 104. Upon detection of the user, the image capturing device 124 may relay input data to the control board 118 to dynamically adjust the brightness of the display unit 110. The adjustment may act as a dimmer switch based on ambient light or proximity detection to prevent eye strain or discomfort caused by high brightness levels, particularly in low-light environments. The system 100 may improve user experience by adapting the display unit 110 brightness in real time depending on environmental or user-triggered conditions.

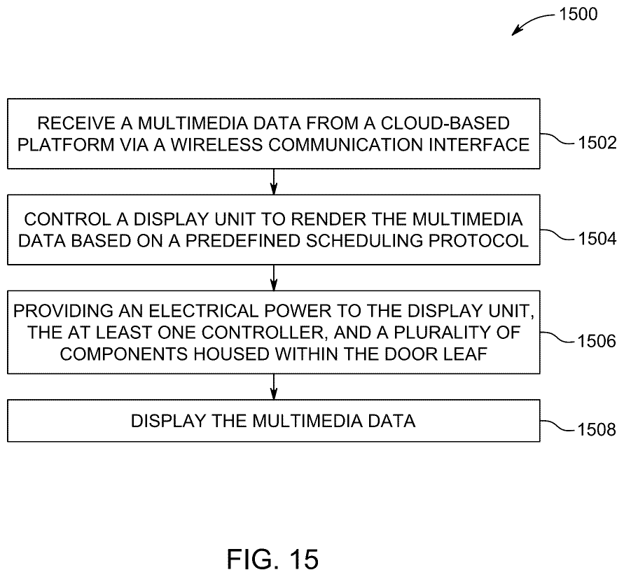

FIG. 15 illustrates a flowchart showing a method 1500 for operating the multifunctional digital door system 100 in accordance with an example embodiment of the present disclosure.

At operation 1502, the at least one processor 202 receives the multimedia data from the cloud-based platform via the wireless communication interface. The at least one processor 202 manages, control, and update the multimedia data displayed on the display unit 110. The at least one processor 202 receives the multimedia data from one or more remote sources. The one or more remote sources includes the cloud-based content management platform. The at least one processor 202 is operable to establish communication with the cloud-based platform through a wireless communication interface. The wireless communication interface includes one or more communication technologies. The one or more communication technologies comprises at least one of Wi-Fi, Bluetooth, Zigbee, or a cellular communication protocol.

In one example, the at least one processor 202 receives a promotional banner from the cloud server over Wi-Fi and stores it for upcoming display on the display unit 110.

At operation 1504, the at least one processor 202 controls the display unit 110 to render the multimedia data based on the predefined scheduling protocol. The predefined scheduling protocol defines specific rules or instructions that determines when and how the different multimedia data is to be presented on the display unit 110. The at least one processor 202 executes the predefined scheduling protocol to ensure that the multimedia content data is shown at intended times and durations. The at least one processor 202 allows for a seamless user experience while optimizing visibility of the multimedia data based on time-sensitive requirements.

In one example, lunch offers are scheduled to appear between 12 PM to 3 PM, while evening ads are shown after 5 PM automatically.

At operation 1506, the power supply unit 112 provides the electrical power to the display unit 110, the at least one processor, and the plurality of components 114 housed within the door leaf 104. The power supply unit 112 receives the electrical power from an external wall outlet. In one example, the power supply unit 112 includes power input circuitry for converting alternating current (AC) from the external wall outlet into a suitable direct current (DC) voltage required by the plurality of components 114 of the door leaf 104. The power supply unit 112 optionally comprises protective features such as surge protection, thermal cutoffs, and overcurrent safeguards to ensure safe operation.

In one example, the power unit converts 230V AC to 12V DC to power the display unit 110 and ensures surge protection during voltage fluctuations.

At operation 1508, the display unit 110 displays the multimedia data. The display unit 110 is a double-sided display and is operable to display the multimedia data while the door leaf 104 remains functional for the ingress and the egress operations. The display unit 110 is operable to function in both interior-facing and exterior-facing directions, thereby enhancing visibility for the user on either side of the door leaf 104. The display unit 110 allows for uninterrupted ingress and egress operations. In one example, the display unit 110 maintains high brightness and contrast for outdoor visibility and may support high-definition or ultra-high-definition resolutions. The front panel positioned over the door leaf 104 is used on both sides of the door leaf 104. The front panel sheet is rigid, lightweight, and takes high impact without breaking or shattering.

In one example, a “Sale 50% Off” ad is displayed in bright red on both sides of the door, viewable by people entering and exiting the store.

The present disclosure offers several notable advantages. The multifunctional digital door system 100 comprises the display unit 110 directly into the door leaf 104, thereby eliminating the need for separate signage installations and maximizing available storefront space. The embedded display unit 110 enables dynamic and customizable multimedia data delivery, allowing real-time updates for promotions, access control messages, and branding without structural modifications. The modular design of the door leaf 104 and associated mounting components facilitates easy maintenance, component replacement, and future upgrades. Furthermore, the multifunctional digital door system 100 supports interactive and sensor-based features that enhance user engagement and operational automation, such as personalized content delivery and access scanning prompts. Overall, the present disclosure provides a cost-effective, space-efficient, and technologically advanced solution for enhancing commercial entryways while maintaining full door functionality.

Many modifications and other embodiments of the present disclosure set forth herein will come to mind to one skilled in the art to which this present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While the present invention has been described in terms of particular embodiments and applications, in both summarized and detailed forms, it is not intended that these descriptions in any way limit its scope to any such embodiments and applications. It will be understood that many substitutions, changes and variations in the described embodiments, applications and details of the method and system illustrated herein and of their operation can be made by those skilled in the art without departing from the spirit of this invention.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

The present invention has been described with reference to the preferred embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of implementation which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

What is claimed is:

1. A multifunctional door system comprising:
a door leaf configured to be movable relative to a frame assembly, wherein the door leaf comprises:
a display unit integrated into the door leaf and viewable through a front panel, wherein the display unit is configured to display a multimedia data;
a memory having one or more computer readable instructions;
at least one processor disposed within the door leaf and operatively coupled to the display unit, wherein the at least one processor is configured to:
receive the multimedia data from a remote cloud-based platform via a wireless communication interface; and
control the display unit to render the multimedia data based on a predefined scheduling protocol; and
a power supply unit operationally coupled to the at least one processor, wherein the power supply unit is configured to provide an electrical power to the display unit, the at least one processor, and a plurality of components housed within the door leaf,
wherein the display unit is a double-sided display and is operable to display the multimedia data while the door leaf remains functional for entry and egress operations.

2. The multifunctional door system of claim 1, wherein the frame assembly comprises a pair of jambs, a header, and a threshold configured to mount the door leaf within a building opening.

3. The multifunctional door system of claim 2, wherein the pair of jambs are configured to support mounting of one or more pivot hinges for an unobstructed movement of the door leaf, and wherein the header includes a door closer configured to automatically return the door leaf to a second position from a first position, wherein the first position is an open state of the door leaf and the second position is a closed state of the door leaf.

4. The multifunctional door system of claim 1, wherein the plurality of components comprises at least of an image capturing device, an alert unit, a speaker, a QR scanner, a cooling system, a safety assistance unit, and a data analytics unit, each operatively coupled to the at least one processor, wherein the at least one processor is further configured to selectively activate one or more of the plurality of components in response to predefined conditions, environmental triggers, or a user input.

5. The multifunctional door system of claim 4, wherein the cooling system comprises at least one intake fan and at least one exhaust fan configured to create a directional airflow within the door leaf, and wherein each of the at least two intake fan and the at least two exhaust fan is equipped with a mesh filter configured to block one or more debris from entering an internal compartment of the door leaf.

6. The multifunctional door system of claim 1, wherein the at least one processor is further configured to implement the predefined scheduling protocol, wherein the predefined scheduling protocol enables a timed delivery and display of the multimedia data based on predefined time intervals, calendar schedules, or one or more environmental conditions.

7. The multifunctional door system of claim 1, wherein the multimedia data comprises at least one of advertising media, promotional content, public safety alerts, venue-specific information, venue-specific safety instructions, or real-time environmental notifications.

8. The multifunctional door system of claim 1, wherein the power supply unit is configured to:
receive the electrical power from a wall outlet: and
distribute the electrical power to the display unit, the at least one processor, and the plurality of components within the door leaf.

9. The multifunctional door system of claim 1, wherein the door leaf comprises a top rail and a bottom rail, wherein the top rail includes an access panel housing one or more electrical components comprising at least one of a power switch, a control circuitry, electrical wiring, or a power distribution element, and wherein the bottom rail includes a kick plate to assist a manual operation of the door leaf.

10. A method comprising:
receiving, via at least one processor disposed within a door leaf, a multimedia data from a remote cloud-based platform via a wireless communication interface;
controlling, via the at least one processor, a display unit to render the multimedia data based on a predefined scheduling protocol;
providing, via a power supply unit operationally coupled to the at least one processor, an electrical power to the display unit, the at least one processor, and a plurality of components housed within the door leaf; and
displaying, via the display unit, the multimedia data,
wherein the display unit is a double-sided display and is operable to display the multimedia data while the door leaf remains functional for entry and egress operations.

11. The method of claim 10, wherein the frame assembly comprises a pair of jambs, a header, and a threshold configured to mount the door leaf within a building opening.

12. The method of claim 11, further comprising:
supporting, via the pair of jambs, mounting of one or more pivot hinges for an unobstructed movement of the door leaf, and
returning, via a door closer integrated within a header, the door leaf to a second position from a first position,
wherein the first position is an open state of the door leaf and the second position is a closed state of the door leaf.

13. The method of claim 10, wherein the plurality of components comprises at least of an image capturing device, an alert unit, a speaker, a QR scanner, a cooling system, a safety assistance unit, and a data analytics unit, each operatively coupled to the at least one processor, wherein the at least one processor is further configured to selectively activate one or more of the plurality of components in response to predefined conditions, environmental triggers, or a user input.

14. The method of claim 13, wherein the cooling system comprises at least one intake fan and at least one exhaust fan configured to create a directional airflow within the door leaf, and wherein each of the at least one intake fan and the at least one exhaust fan is equipped with a mesh filter configured to block one or more debris from entering an internal compartment of the door leaf.

15. The method of claim 11 further comprising:
implementing, via the at least one processor, the predefined scheduling protocol,
wherein the predefined scheduling protocol enables a timed delivery and display of the multimedia data based on predefined time intervals, calendar schedules, or one or more environmental conditions.

16. The method of claim 11, wherein the multimedia data comprises at least one of advertising media, promotional content, public safety alerts, venue-specific information, venue-specific safety instructions, or real-time environmental notifications.

17. The method of claim 11 further comprising:
receiving, via the power supply unit, the electrical power from a wall outlet: and
distributing, via the power supply unit, the electrical power to the display unit, the at least one processor, and the plurality of components within the door leaf.

18. The method of claim 11, wherein the door leaf comprises a top rail and a bottom rail, wherein the top rail includes an access panel housing one or more electrical components comprising at least one of a power switch, a control circuitry, electrical wiring, or a power distribution element, and wherein the bottom rail includes a kick plate to assist a manual operation of the door leaf.

19. A multifunctional door comprising:
a frame assembly mounted within an architectural opening; and
a door leaf coupled with the frame assembly, wherein the door leaf comprising:
a display unit integrated into the door leaf and viewable through a front panel, wherein the display unit is configured to display a multimedia data, wherein the display unit is a double-sided display and is operable to display the multimedia data while the door leaf remains functional for entry and egress operations, wherein the display unit is secured within the door leaf using one or more mounting rods and a plurality of impact rods positioned adjacent to the display unit for structural support and impact protection; and
a top rail and a bottom rail, wherein the top rail includes an access panel housing one or more electrical components comprising at least one of a power switch, a control circuitry, electrical wiring, or a power distribution element, and wherein the bottom rail includes a kick plate to assist a manual operation of the door leaf.

20. The multifunctional door of claim 19, wherein the pair of jambs are configured to support mounting of one or more pivot hinges for an unobstructed movement of the door leaf, and wherein the header includes a door closer configured to automatically return the door leaf to a second position from a first position, wherein the first position is an open state of the door leaf and the second position is a closed state of the door leaf.
